(19) United States
(12) Patent Application Publication
(10) Pub. No.: US 2025/0365380 A1
(43) Pub. Date: Nov. 27, 2025

(54) INFORMATION PROCESSING SYSTEM, SERVER APPARATUS, AND NON-TRANSITORY COMPUTER-READABLE RECORDING MEDIUM

(71) Applicant: KYOCERA DOCUMENT SOLUTIONS INC., OSAKA (JP)

(72) Inventors: DAIJIRO KITAMOTO, OSAKA (JP); MASAHIRO SUZUKI, OSAKA (JP); RYOTA YAGANE, OSAKA (JP); MOTOKI HIRATSUKA, OSAKA (JP)

(21) Appl. No.: 19/218,579

(22) Filed: May 26, 2025

(30) Foreign Application Priority Data
May 27, 2024 (JP) 2024-085437

(51) Int. Cl. H04N 1/32; H04L 9/32; H04L 67/565

(52) U.S. Cl. CPC H04N 1/32416; H04L 9/3213; H04L 67/565

(57) ABSTRACT

An information processing system includes an information processing apparatus and a server apparatus. A registration request unit of the information processing apparatus sets URL and access code of a service provided by the server apparatus, and generates an agent ID and sends the agent ID and an agent type to the server apparatus. An agent registration unit of the server apparatus receives the agent ID, and generates an access token for the agent ID and sends the access token and a refresh token for the access token to the information processing apparatus. The registration request unit receives the access token and the refresh token and sends the access token and agent properties to the server apparatus. The agent registration unit receives the access token and the agent properties and registers the agent properties and the refresh token as agent information of the information processing apparatus in a list.

### CROSS-REFERENCE TO RELATED PATENT APPLICATION

This application claims the benefit of Japanese Priority Patent Application JP 2024-085437 filed May 27, 2024, the entire contents of which are incorporated herein by reference.

### FIELD OF THE DISCLOSURE

The present disclosure relates to an information processing system, a server apparatus, an information processing program, and a non-transitory computer-readable recording medium recording the information processing program that migrate data between information processing apparatuses.

### BACKGROUND OF THE DISCLOSURE

Migration data such as setting information is sometimes migrated between information processing apparatuses (e.g., image forming apparatuses such as multifunction peripherals (MFPs)). For example, when an information processing apparatus is replaced by another information processing apparatus, migration data of the information processing apparatus as a migration source is migrated to the information processing apparatus as a migration destination.

### SUMMARY OF THE DISCLOSURE

An information processing system according to an embodiment of the present disclosure includes an information processing apparatus and a server apparatus. The information processing apparatus includes a registration request unit that sets URL and access code of a service provided by the server apparatus to the information processing apparatus itself, and generates an agent ID identifying the information processing apparatus itself and sends the agent ID and an agent type to the server apparatus. The server apparatus includes an agent registration unit that receives the agent ID from the information processing apparatus, and generates an access token for the agent ID and sends the access token and a refresh token for the access token to the information processing apparatus. The registration request unit of the information processing apparatus receives the access token and the refresh token from the server apparatus and sends the access token and agent properties to the server apparatus. The agent registration unit of the server apparatus receives the access token and the agent properties from the information processing apparatus and registers the agent properties and the refresh token as agent information of the information processing apparatus in a list.

A server apparatus according to an embodiment of the present disclosure includes an agent registration unit. The agent registration unit receives an agent ID from an information processing apparatus. The agent registration unit generates an access token for the agent ID. The agent registration unit sends the access token and a refresh token for the access token to the information processing apparatus including a registration request unit that sets URL and access code of a service provided by the server apparatus to the information processing apparatus itself, generates the agent ID identifying the information processing apparatus itself, and sends the agent ID and an agent type to the server apparatus. When the registration request unit of the information processing apparatus receives the access token and the refresh token from the server apparatus and sends the access token and agent properties to the server apparatus, the agent registration unit receives the access token and the agent properties from the information processing apparatus. The agent registration unit registers the agent properties and the refresh token as agent information of the information processing apparatus in a list.

An information processing program recorded on a non-transitory computer-readable recording medium according to an embodiment of the present disclosure causes a computer for a server apparatus to operate as an agent registration unit. The agent registration unit receives an agent ID from an information processing apparatus, generates an access token for the agent ID, and sends the access token and a refresh token for the access token to the information processing apparatus including a registration request unit that sets URL and access code of a service provided by the server apparatus to the information processing apparatus itself, generates the agent ID identifying the information processing apparatus itself, and sends the agent ID and an agent type to the server apparatus. When the registration request unit of the information processing apparatus receives the access token and the refresh token from the server apparatus and sends the access token and agent properties to the server apparatus, the agent registration unit receives the access token and the agent properties from the information processing apparatus. The agent registration unit registers the agent properties and the refresh token as agent information of the information processing apparatus in a list.

These and other objects, features and advantages of the present disclosure will become more apparent in light of the following detailed description of best mode embodiments thereof, as illustrated in the accompanying drawings.

### BRIEF DESCRIPTION OF THE DRAWINGS

FIG. 1 shows an information processing system according to an embodiment of the present disclosure.

FIG. 2 shows a hardware configuration of an image forming apparatus used as an information processing apparatus.

FIG. 3 shows a functional configuration of the information processing system.

FIG. 4 shows a sequence of registering an information processing apparatus on a server apparatus.

FIG. 5 shows a sequence of a server apparatus collecting migration data from a first information processing apparatus (migration source).

FIG. 6 shows a flowchart of the server apparatus collecting the migration data from the first information processing apparatus (migration source).

FIG. 7 shows a sequence of a second information processing apparatus (migration destination) receiving the migration data from the server apparatus.

FIG. 8 shows a flowchart of the second information processing apparatus (migration destination) receiving the migration data from the server apparatus.

### DETAILED DESCRIPTION OF THE EXEMPLARY EMBODIMENTS

Hereinafter, embodiments of the present disclosure will be described below with reference to the drawings.

### 1. INFORMATION PROCESSING SYSTEM

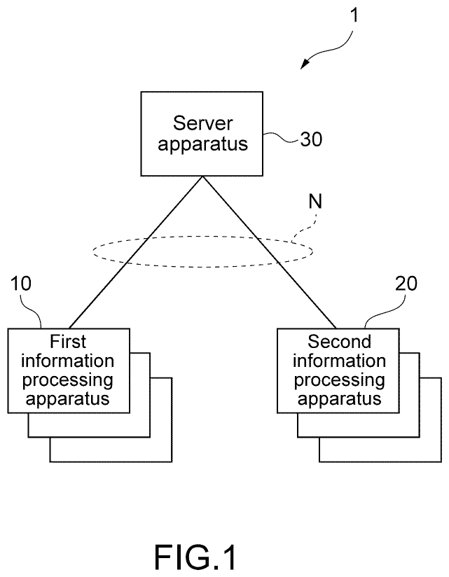

FIG. 1 shows an information processing system according to an embodiment of the present disclosure.

An information processing system 1 includes at least one first information processing apparatus 10, at least one second information processing apparatus 20, and a server apparatus 30. The at least one first information processing apparatus 10, the at least one second information processing apparatus 20, and the server apparatus 30 are connected to a network, e.g., the Internet, and they are capable of communicating with each other.

The first information processing apparatus 10 and the second information processing apparatus 20 may be image forming apparatuses, e.g., multifunction peripherals (MFPs). However, the first information processing apparatus 10 and the second information processing apparatus 20 are not limited to the MFPs. Any electronic apparatuses may be employed as long as they are of the same type and capable of communicating.

In the present embodiment, when an information processing apparatus is replaced by another information processing apparatus, migration data of the information processing apparatus as a migration source is migrated to the information processing apparatus as a migration destination. The first information processing apparatus 10 is an old apparatus as the migration source (before replacement) and the second information processing apparatus 20 is a new apparatus as the migration destination (after replacement). The migration data is, for example, setting information of the first information processing apparatus 10. For example, the migration data includes setting data for defining operations of the first information processing apparatus 10, an address book relating to a user who uses the first information processing apparatus 10 and business partner users (e.g., sending sources of FAX and mail), image data accumulated by each user, and the like.

### 2. HARDWARE CONFIGURATION OF IMAGE FORMING APPARATUS

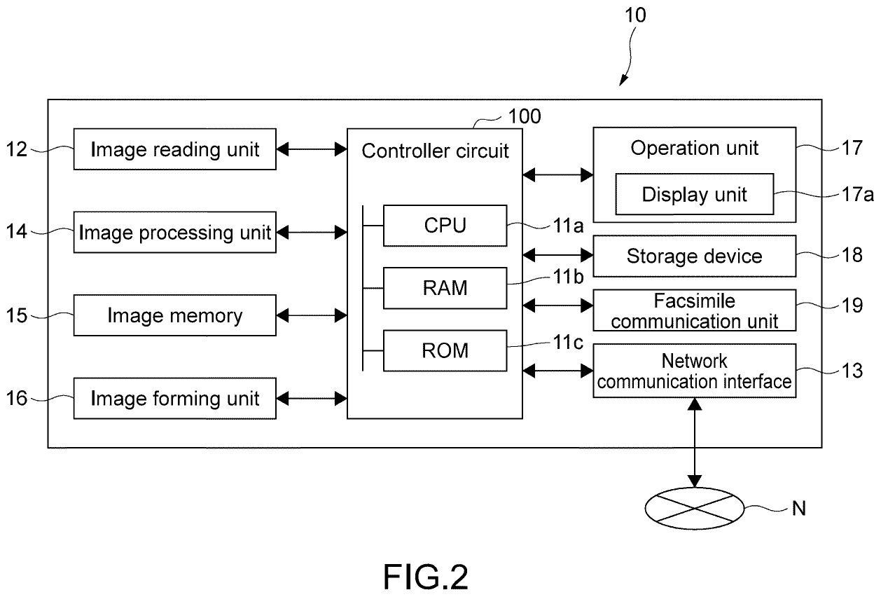

FIG. 2 shows a hardware configuration of an image forming apparatus used as an information processing apparatus.

In a case where the first information processing apparatus 10 and the at least one second information processing apparatus 20 are image forming apparatuses, they have similar hardware configurations. Therefore, a hardware configuration of one image forming apparatus 10 will be described as a representative.

The image forming apparatus 10 includes a control circuit 100 that constitutes a computer. The control circuit 100 is constituted by a central processing unit (CPU) 11a, which is a processor, a random access memory (RAM) 11b, a read only memory (ROM) 11c, which is a memory, a dedicated hardware circuit, and the like. The control circuit 100 serves to comprehensively control the operation of the image forming apparatus 10. By loading the information processing program stored on the ROM 11c to the RAM 11b and executing the information processing program, the CPU 11a executes an operation described in the following operation flow and controls the display and operation input on a touch panel 17. The ROM 11c permanently stores the program, data, and the like executed by the CPU 11a. The ROM 11c is an example of a non-transitory computer-readable recording medium.

The control circuit 100 is connected to an image reading unit 12 (image scanner), an image processing unit 14 (including graphics processing unit (GPU)), an image memory 15, an image forming unit 16 (printer), a touch panel (front panel) 17, which is an operation unit including a display unit 17a, a large-volume non-volatile storage device 18, such as a hard disk drive (HDD) or a solid state drive (SSD), a facsimile communication unit 19, a network communication interface 13 (communication unit), and the like. The control circuit 100 controls the operations of the above-mentioned respective parts connected and exchanges signals and data with the respective parts. The operation unit of the touch panel 17 is an embodiment of an input device. An audio input device including a microphone may be provided as the input device.

### 3. FUNCTIONAL CONFIGURATION OF INFORMATION PROCESSING SYSTEM

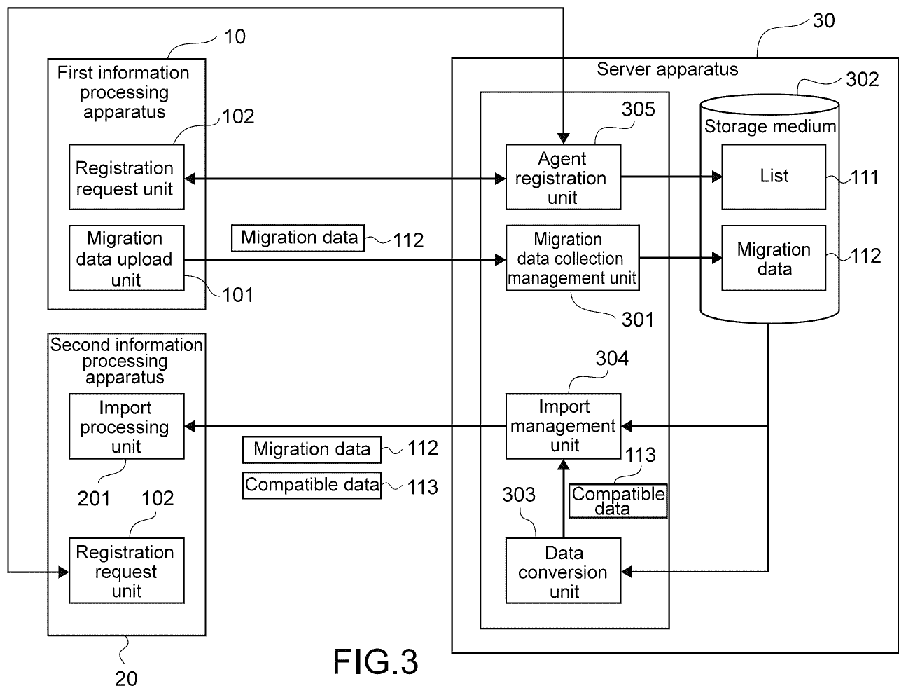

FIG. 3 shows a functional configuration of the information processing system.

Regarding both the first information processing apparatus 10 as the migration source of the migration data and the second information processing apparatus 20 as the migration destination, the information processing apparatuses 10 and 20 commonly operates as registration request units 102 by the computer executing the information processing program. The first information processing apparatus 10 as the migration source operates as a migration data upload unit 101 by the computer executing the information processing program. The second information processing apparatus 20 as the migration destination operates as an import processing unit 201 by the computer executing the information processing program. The server apparatus 30 operates as a migration data collection management unit 301, a data conversion unit 303, an import management unit 304, and an agent registration unit 305 by the computer executing the information processing program.

4-1. Operation of Information Processing System (during Registration)

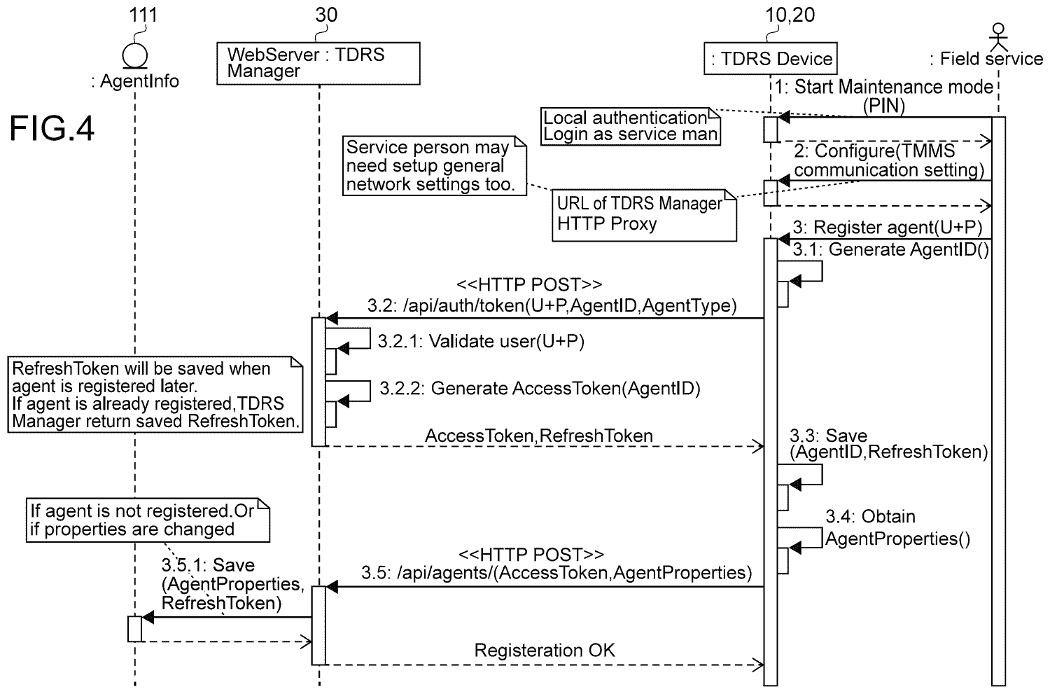

FIG. 4 shows a sequence of registering an information processing apparatus on a server apparatus.

Hereinafter, the term “the information processing apparatus 10, 20” means either the first information processing apparatus 10 as the migration source or the second information processing apparatus 20 as the migration destination information processing apparatus, not distinguishing them.

A service person (user) performs local authentication and inputs PIN in the information processing apparatus 10, 20, logs in as a serviceman, and starts a maintenance mode (Step 1). The registration request unit 102 of the information processing apparatus 10, 20 sets URL, access code, and proxy of a service provided by the server apparatus 30 to the information processing apparatus 10, 20 itself via operation inputs from the service person and performs communication setting (Step 2). At this time, the service person may perform general network setting if necessary.

The registration request unit 102 of the information processing apparatus 10, 20 starts processing of registering the information processing apparatus 10, 20 on the server apparatus 30 as an agent via operation inputs from the service person (user) (Step 3). First of all, the registration request unit 102 generates the agent ID identifying the information processing apparatus 10, 20 itself (Step 3.1). The registration request unit 102 sends the user information, the agent ID, the agent type, and the like to the server apparatus 30 (Step 3.2).

The agent registration unit 305 of the server apparatus 30 receives the user information, the agent ID, the agent type, and the like from the information processing apparatus 10, 20 and performs user validation (Step 3.2.1). When the user validation is successful, the agent registration unit 305 generates an access token for the agent ID (Step 3.2.2).

Here, a refresh token is stored in a case where the agent is registered later. In a case where the agent has already been registered, the stored refresh token is sent to the information processing apparatus 10, 20. The refresh token retains information required for obtaining a new access token and is used for obtaining the new access token in a case where the access token has expired. The agent registration unit 305 of the server apparatus 30 sends the access token and the refresh token for the access token to the information processing apparatus 10, 20.

The registration request unit 102 of the information processing apparatus 10, 20 receives the access token and the refresh token from the server apparatus 30, stores the refresh token, and the agent ID (Step 3.3), and obtains agent properties (Step 3.4). The registration request unit 102 sends the access token and the agent properties to the server apparatus 30 (Step 3.5).

The agent registration unit 305 of the server apparatus 30 receives the access token and the agent properties from the information processing apparatus 10, 20, registers the agent properties and the refresh token in a list 111 as agent information of the information processing apparatus 10, 20, and records the list 111 on a storage medium 302 (Step 3.5.1). In a case where the agent information has not been registered or in a case where the agent properties have been changed, the agent registration unit 305 registers them as the agent information. The agent registration unit 305 sends a successful registration notification to the information processing apparatus 10, 20.

4-2. Operation of Information Processing System (during Data Migration)

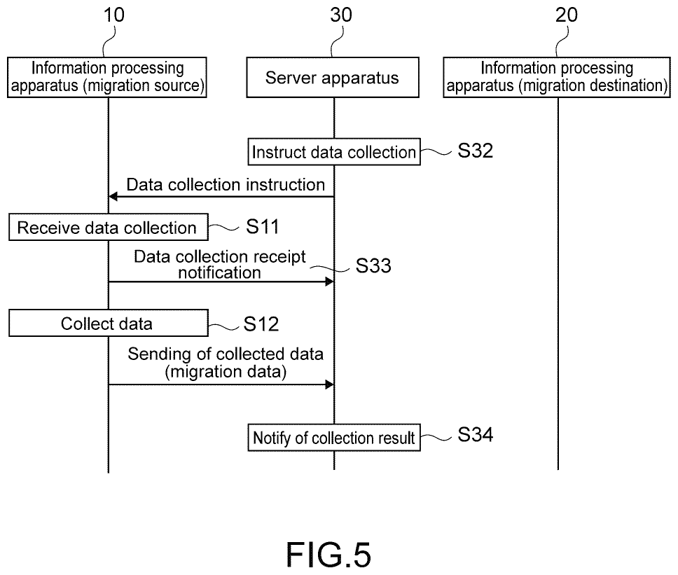

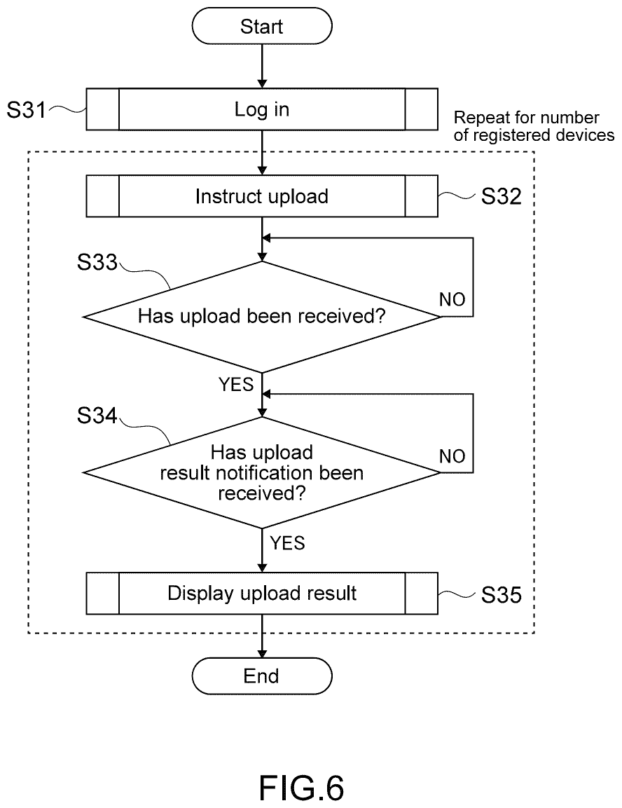

FIG. 5 shows a sequence of the server apparatus collecting migration data from a first information processing apparatus (migration source). FIG. 6 shows a flowchart of the server apparatus collecting the migration data from the first information processing apparatus (migration source).

The user uses, for example, a mobile device (e.g., a smartphone) to log in the server apparatus 30 (Step S31). The server apparatus 30 causes the user to select from the plurality of information processing apparatuses 10, 20 included in the list 111 at least one first information processing apparatus 10 as a migration source of the migration data and at least one second information processing apparatus 20 as a migration destination of the migration data.

The migration data collection management unit 301 of the server apparatus 30 sends a data collection instruction to the first information processing apparatus 10 included in the list 111 (Step S32).

The migration data upload unit 101 of the first information processing apparatus 10 receives the data collection instruction from the server apparatus 30 and sends a data collection receipt notification to the server apparatus 30 (Step S11).

The migration data collection management unit 301 of the server apparatus 30 receives the data collection receipt notification from the first information processing apparatus 10 (YES in Step S33).

The migration data upload unit 101 of the first information processing apparatus 10 collects migration data 112, sends (uploads) the collected migration data 112 to the server apparatus 30, and sends a collection result notification of the migration data 112 to the server apparatus 30. Specifically, the migration data upload unit 101 sends (uploads) migration data 112, which is recorded on the first information processing apparatus 10 and is a migration target, to the server apparatus 30 (Step S12).

The migration data collection management unit 301 of the server apparatus 30 receives the migration data 112 and the collection result notification from the first information processing apparatus 10 (YES in Step S31). The migration data collection management unit 301 stores the migration data 112 on the storage medium 302 and displays an upload result so that the user can view the upload result (on a mobile device or the like of the user) (Step S35). The migration data collection management unit 301 of the server apparatus 30 may send an upload result notification to the first information processing apparatus 10. The upload result notification indicates a success or failure of receipt and storage of the migration data 112.

When the migration data upload unit 101 of the first information processing apparatus 10 receives the upload result notification from the server apparatus 30, the migration data upload unit 101 displays the upload result notification on, for example, the touch panel 17 or the mobile device. In a case where the upload result notification indicates the success, the migration data upload unit 101 closes the upload job. In a case where the displayed upload result notification indicates the failure, the user retries from Step S31.

In a case where a plurality of first information processing apparatuses 10 as migration sources (before replacement) has been registered in the list, the migration data collection management unit 301 of the server apparatus 30 repeats the processing of Step S32 and the subsequent steps on all the plurality of first information processing apparatuses 10 registered.

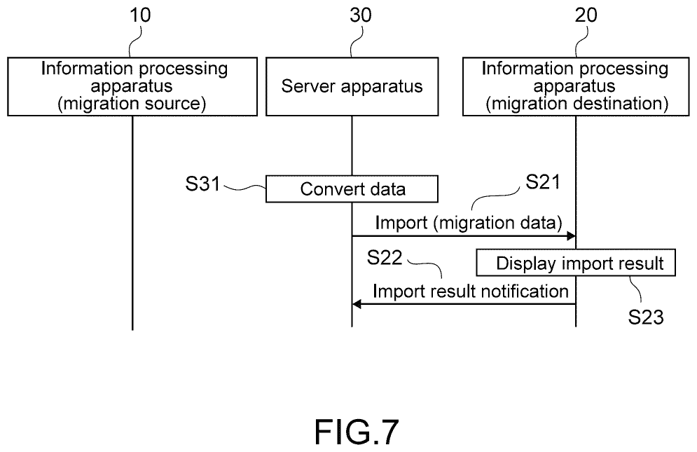

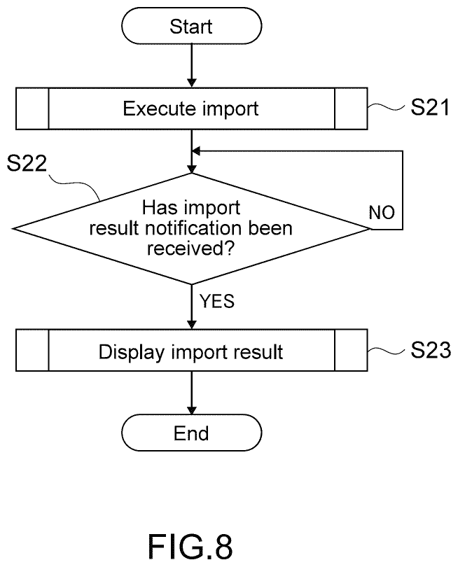

FIG. 7 shows a sequence of a second information processing apparatus (migration destination) receiving the migration data from the server apparatus. FIG. 8 shows a flowchart of the second information processing apparatus (migration destination) receiving the migration data from the server apparatus.

In a case where the device type of the first information processing apparatus 10 registered in the list 111 is different from the device type of the second information processing apparatus 20, the data conversion unit 303 of the server apparatus 30 generates compatible data 113 by converting the migration data 112 so that the migration data 112 is compatible with the device type of the second information processing apparatus 20 (Step S31).

The import management unit 304 of the server apparatus 30 sends to the second information processing apparatus 20 the migration data 112 (in a case where the device types are the same) or the converted compatible data 113 (in a case where the device types are different).

The import processing unit 201 of the second information processing apparatus 20 receives the migration data 112 or the compatible data 113 from the server apparatus 30 and records (imports) the migration data 112 or the compatible data 113 on the second information processing apparatus 20 (Step S25). When the import is completed, the import processing unit 201 sends an import result notification to the server apparatus 30 (Step S26) and displays the import result notification on, for example, the touch panel 17 or the mobile device (Step S27). The order of Steps S26 and S27 is not limited. In a case where the import result notification indicates the success, the server apparatus 30 closes the import job. In a case where the displayed import result notification indicates the failure, the user retries from Step S21.

### 4. CONCLUSION

According to the related technology, it is necessary to input and retain a device number of an information processing apparatus as a migration destination by an information processing apparatus as a migration source of migration data. Therefore, if there are a large number of information processing apparatuses as migration destinations, the user needs to input a large number of device numbers through an information processing apparatus as a migration source, and it takes time and effort for the user.

On the other hand, according to the present embodiment, the server apparatus 30 retains the list 111 of the information processing apparatus 10, 20 and causes the user to select the at least one first information processing apparatus 10 as the migration source of the migration data and the at least one second information processing apparatus 20 as the migration destination of the migration data. The server apparatus 30 collects the migration data of the first information processing apparatus 10 as the at least one migration source. The second information processing apparatus 20 as the migration destination receives the migration data from the server apparatus 30.

Accordingly, the user does not need to input the device number of the information processing apparatus as the migration destination by the information processing apparatus as the migration source. Thus, the user's time and effort can be saved especially in a case of migrating the migration data of the first information processing apparatus 10 as the migration source to a plurality of second information processing apparatuses 20 as migration destinations.

Although each embodiment and each modified example of the present technology have been described above, the present technology is not limited to the above-mentioned embodiments, and various modifications can be made without departing from the gist of the present technology as a matter of course.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing system, comprising:
an information processing apparatus including a registration request unit that
sets URL and access code of a service provided by a server apparatus to the information processing apparatus itself, and
generates an agent ID identifying the information processing apparatus itself and sends the agent ID and an agent type to the server apparatus; and
the server apparatus including an agent registration unit that
receives the agent ID from the information processing apparatus, and
generates an access token for the agent ID and sends the access token and a refresh token for the access token to the information processing apparatus, wherein
the registration request unit of the information processing apparatus receives the access token and the refresh token from the server apparatus and sends the access token and agent properties to the server apparatus, and
the agent registration unit of the server apparatus receives the access token and the agent properties from the information processing apparatus and registers the agent properties and the refresh token as agent information of the information processing apparatus in a list.

2. The information processing system according to claim 1, wherein
the agent registration unit of the information processing apparatus registers agent information of a plurality of information processing apparatuses in the list,
the server apparatus causes a user to select a first information processing apparatus as a migration source of migration data and a second information processing apparatus as a migration destination of the migration data from the plurality of information processing apparatuses included in the list,
the first information processing apparatus includes
a migration data upload unit that sends the migration data to the server apparatus when the migration data upload unit receives a data collection instruction from the server apparatus, the migration data being recorded in the first information processing apparatus and being a migration target,
the server apparatus includes
a migration data collection management unit that sends the data collection instruction to the first information processing apparatus, receives the migration data from the first information processing apparatus, and stores the migration data on a storage medium, and
an import management unit that sends the migration data to the second information processing apparatus, and
the second information processing apparatus includes
an import processing unit that receives the migration data from the server apparatus and records the migration data in the second information processing apparatus.

3. The information processing system according to claim 2, wherein
the server apparatus further includes
a data conversion unit that generates, in a case where a device type of the first information processing apparatus is different from a device type of the second information processing apparatus, compatible data by converting the migration data so that the migration data is compatible with the device type of the second information processing apparatus,
the import management unit of the server apparatus sends the compatible data to the second information processing apparatus, and
the import processing unit of the second information processing apparatus receives the compatible data and records the compatible data on the second information processing apparatus.

4. The information processing system according to claim 2, further comprising
a plurality of the second information processing apparatuses.

5. A server apparatus, comprising
an agent registration unit that
receives an agent ID from an information processing apparatus, generates an access token for the agent ID, and sends the access token and a refresh token for the access token to the information processing apparatus including a registration request unit that sets URL and access code of a service provided by the server apparatus to the information processing apparatus itself, generates the agent ID identifying the information processing apparatus itself, and sends the agent ID and an agent type to the server apparatus, and
receives, when the registration request unit of the information processing apparatus receives the access token and the refresh token from the server apparatus and sends the access token and agent properties to the server apparatus, the access token and the agent properties from the information processing apparatus and registers the agent properties and the refresh token as agent information of the information processing apparatus in a list.

6. A non-transitory computer-readable recording medium recording an information processing program that causes a computer for a server apparatus to operate as
an agent registration unit that
receives an agent ID from an information processing apparatus, generates an access token for the agent ID, and sends the access token and a refresh token for the access token to the information processing apparatus including a registration request unit that sets URL and access code of a service provided by the server apparatus to the information processing apparatus itself, generates the agent ID identifying the information processing apparatus itself, and sends the agent ID and an agent type to the server apparatus, and
receives, when the registration request unit of the information processing apparatus receives the access token and the refresh token from the server apparatus and sends the access token and agent properties to the server apparatus, the access token and the agent properties from the information processing apparatus and registers the agent properties and the refresh token as agent information of the information processing apparatus in a list.
